(19) United States
(12) Patent Application Publication
(10) Pub. No.: US 2024/0413619 A1
(43) Pub. Date: Dec. 12, 2024

(54) ADJUSTABLE SWITCHGEAR FOR RETROFIT APPLICATIONS AND METHOD

(71) Applicant: S&C Electric Company, Chicago, IL (US)

(72) Inventors: Eliseo Navarrete, Chicago, IL (US); David J. Beseda, Park Ridge, IL (US); Rahul Jain, Evanston, IL (US); James F. Fargo, Winnetka, IL (US)

(73) Assignee: S&C Electric Company, Chicago, IL (US)

(21) Appl. No.: 18/676,335

(22) Filed: May 28, 2024

Related U.S. Application Data
(60) Provisional application No. 63/471,446, filed on Jun. 6, 2023.

(51) Int. Cl. H02B 1/46; H02B 13/00

(52) U.S. Cl. CPC H02B 1/46; H02B 13/00

(57) ABSTRACT

Switchgear with an insulated enclosure with interconnection bushings secured to an exterior of the enclosure to provide an electrical connection from conductors to components disposed within the enclosure. A mounting stand is provided that is adapted to be secured to a pad. Existing electrical conductors extend from the pad. The mounting stand includes mounting members. The enclosure includes mounting points. The mounting members are formed with a plurality of mounting locations, and the mounting points are aligned to a mounting location such that the bushings are sufficiently aligned with the conductors to allow interconnection using standard connectors.

### CROSS-REFERENCE TO RELATED APPLICATION

This application claims the benefit of priority from the U.S. Provisional Application No. 63/471,446, filed on Jun. 6, 2023, the disclosure of which is hereby expressly incorporated herein by reference for all purposes.

### BACKGROUND

### Field

This disclosure relates generally to a switchgear and mounting stand assembly suitable for initial or retrofit applications that is adjustable on site to match switchgear bushings to cable heights and to a method of retrofitting switchgear.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeders that carry the same or similar current but are 120° apart in phase. three-phase and single-phase lateral lines are tapped from the feeder that provide the medium voltage to various distribution transformers, where the voltage is stepped down to a low voltage and is provided to loads, such as homes, businesses, etc. Some power distribution networks may employ underground single-phase lateral circuits that feed residential and commercial customers. Frequently, these circuits are configured in a loop and fed from power sources at both ends, where an open circuit location in the loop isolates the two power sources.

Power distribution networks of the type referred to above typically include switching devices, breakers, reclosers, current interrupters, etc. that control the flow of power throughout the network. Standalone pad-mounted and underground switchgear including electrical disconnect switches, fuses and/or circuit breakers used to control, protect and isolate electrical equipment are often employed to de-energize equipment to allow work to be done and to clear faults. Switchgear often include load-interrupter switches, resettable, vacuum fault interrupters and other equipment and components.

Older generations of pad-mounted switchgear employed what is referred to as live front designs. With the enclosing cabinet opened, users are potentially exposed to energized switchgear components. Accordingly, special precautions are required prior to working around such energized equipment.

An alternative to live front switchgear, energized components may be enclosed in a gas-insulated steel tank to provide electrical isolation. The tank is generally hermetically sealed and filled with a dielectric gas. The dielectric gas acts as an insulator having a greater insulating capacity than plain air so that higher voltages can be tolerated and the various electrical components in the tank can be spaced closer together without causing arcing therebetween, which allows the switchgear to be smaller. To provide electrical connection of the electrical components within the sealed housing to the electric grid, interconnection bushings are provided at a fixed location on the exterior of the tank allowing an electrical conductor to pass through the tank from the exterior to the interior in a sealed manner.

As live front switchgear ages and users look to replace and upgrade such equipment, a solution is needed that allows new switchgear, such as gas-insulated switchgear, to be retrofitted onto existing pads and connected to existing conductors.

### SUMMARY

The following discussion discloses and describes switchgear with an isolated enclosure with interconnection bushings secured to an exterior of the enclosure to provide an electrical connection from conductors to components disposed within the enclosure. A mounting stand is provided that is adapted to be secured to a base. Existing electrical conductors extend from the pad. The mounting stand includes mounting members. The enclosure includes mounting points. The mounting members are formed with a plurality of mounting locations, and the mounting points are aligned to a mounting location such that the bushings are sufficiently aligned with the conductors to allow interconnection using standard connectors such as elbow connectors.

In an alternative embodiment, switchgear has an enclosure with interconnection bushings secured to an exterior of the enclosure. A pair of mounting stands is provided that are adapted to be secured to an existing concrete pad. Existing electrical conductors extend from the pad. Each mounting stand includes mounting members. The enclosure includes mounting points. The mounting members are formed with a plurality of mounting locations, and the mounting points are aligned vertically to a mounting location such that the bushings sufficiently align with the conductors to allow interconnection using standard connectors such as elbow connectors.

A method of retrofitting switchgear includes securing a mounting stand assembly to an existing pad from which electrical conductors extend. Mounting points on the switchgear are aligned to one of a plurality of mounting locations formed on the mounting stand assembly such that switchgear bushings are roughly aligned to existing conductors extending from the pad. The switchgear is secured to the mounting stand at the determined location.

Additional features of the disclosure will become apparent from the following description and appended claims, taken in conjunction with the accompanying drawings.

### BRIEF DESCRIPTION OF THE DRAWINGS

FIG. 1 is an isometric view of medium-voltage switchgear including a hermetically sealed and gas insulated tank; and

FIG. 2 is an isometric view of a mounting stand assembly.

### DETAILED DESCRIPTION OF THE EMBODIMENTS

The following discussion of the embodiments of the disclosure directed to electric switchgear including a sealed tank enclosing electrical components.

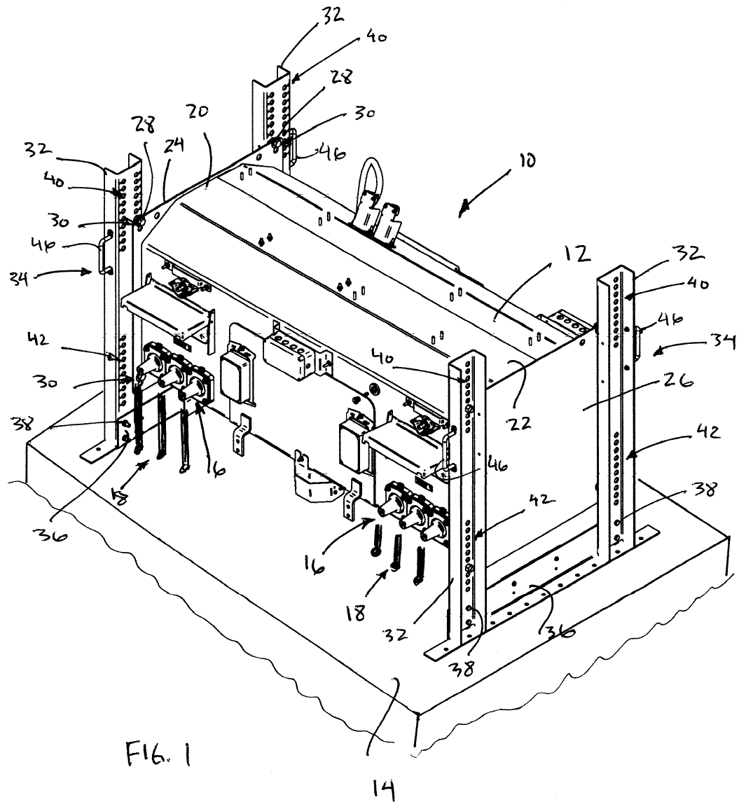

Referring to the Figures, shown in isometric view is medium-voltage switchgear 10 suitable for mounting on a base, e.g., pad 14 and including an enclosure 12. The switchgear 10 is intended to represent any suitable switchgear employed in an electrical power distribution network as discussed above and can include any and all components for a particular application. As depicted in FIG. 1, switchgear 10 includes a number of components not separately identified on an exterior of the enclosure 12 and a plurality of bushings 16 that facilitate electrical connections to conductors 18 from outside the enclosure 12 to electrical components (not depicted) disposed within the enclosure 12 using standard connectors such as elbow connectors.

Secured to ends 20 and 22 of the enclosure 12 are endplates 24 and 26. Endplates 24 and 26 are formed with bolts 28, which may be captive bolts, that define mounting points 30 for the switchgear 10. As depicted, the bushings 14 are fixed in location relative to the bolts 28, and hence, to the mounting points 30.

Mounting stand assemblies 34 are provided and include uprights 32 which are formed with a first set of apertures 40 and a second set of apertures 42. A first mounting stand assembly 34 is secured to end 20 and a second mounting stand assembly 34 is secured to end 22. The first set of apertures 40 and the second set of apertures 42 define a plurality of mounting locations permitting the mounting stand assemblies 34 to be secured to the switchgear 10 to maintain the switchgear 10 at a desired location relative to the pad 14. Being able to position the switchgear 10 at a plurality of locations relative to the pad 14, the switchgear may be positioned to align the bushings 16 to the conductors 18 to allow interconnection of the bushings 16 to the conductors using standard connectors, such as elbow connectors. While the described embodiment shows adjustment in a vertical orientation, similar arrangements may be made to provide adjustment in a horizontal orientation.

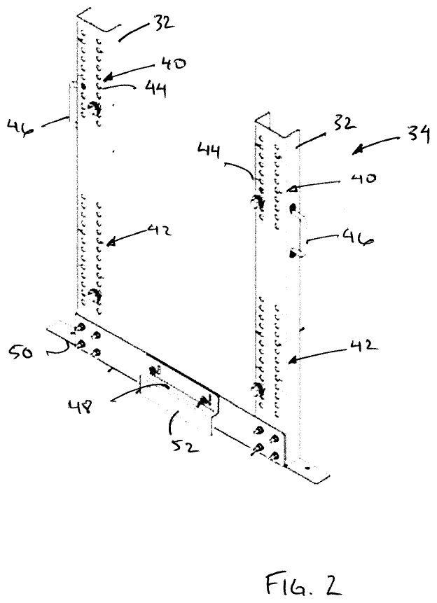

In a typical application, the switchgear 10 is hoisted into position to a desired height above the pad 14. The mounting stand assemblies 32 are then positioned relative to the switchgear 10 such that the bolts 28 pass through a set of the apertures 40 and 42 and mounting flanges 36 engage a surface of the pad 14. To facilitate positioning of the bolts 28 within the apertures 40 and 42, an index (44 in FIG. 2) may be provided relative to one or more of the apertures 40 and 42. Alternatively, the apertures may be numbered, for example, from 1-10 with the mounting stands thus providing 10 different positions for the switchgear 10 above the pad 14.

Once secured to the switchgear 10, the mounting stand assemblies 34 are secured to the pad 14 by mounting flanges 36 using any suitable method. As shown in FIG. 2, handles 46 may be provided to assist positioning and securing of the mounting stand assemblies 34 to the switchgear 10. Once secured to the switchgear 10, the handles 46 may be further used to assist guiding the switchgear 10 to its location on the pad 14.

In certain applications, the switchgear 10 may be positioned over a well (not depicted) formed in the pad 14. With continued reference to FIG. 2, mounting stand assemblies 34 may include positioning flanges 48. Positioning flanges 48 may be disposed in a first position extending above a base surface 50 of mounting flanges 36. In a second position of the positioning flanges 48, flanges 52 extend below the base surface 50. The flanges 52 can then engage a wall of the well to assist positioning of the switchgear 10 on the pad 14 and prevent the switchgear 10 from moving on the pad 14 and relative to the well.

In retrofit applications, an existing piece of pad-mounted switchgear is removed leaving the pad 14 and the conductors 18. The height that the conductors 18 extend above the pad 14 will vary from site-to-site. The switchgear is hoisted into place above the pad 14 with the bushings 16 aligning with the conductors 18 allowing interconnection by standard connectors. Mounting stand assemblies 32 are secured to the switchgear 10, the mounting stand assemblies providing a plurality of mounting locations that permit attachment of the mounting stand assemblies 32 to the switchgear 10 maintaining the switchgear 10 at a desired location above the pad 14 permitting the bushings 16 to be connected to the conductors 18 using standard connectors. Thus, a method of retrofitting existing pad-mounted installations with new switchgear 10 is provided.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A switchgear assembly for retrofit application, the switchgear assembly comprising:
a switchgear enclosure, the enclosure including a first end and a second end, a first end plate secured to the first end and a second end plate secured to the second end, bolts secured at mounting points on the first end plates and the second end plates, and bushings secured to the housing at a fixed location relative to the mounting points, the bushings being configured to electrically connect conductors with electric components disposed within the switchgear enclosure; and
mounting stands including a plurality of apertures defining a plurality of mounting locations, the apertures configured to receive the bolts at one of the plurality of mounting locations such that the mounting stand supports the switchgear enclosure at a fixed relationship to a pad such that electric conductors extending from the pad are sufficiently aligned to permit connection of the conductors with the bushings.

2. A method of retrofitting switchgear comprising:
removing an existing switchgear from a pad leaving the pad and conductors, the conductors extending from the pad;
disposing a replacement switchgear at a position relative to the pad and conductors such that bushings disposed on the switchgear sufficiently align with the conductors to allow interconnection of the conductors with the bushings;
securing mounting stands to the switchgear to maintain the position of the switchgear relative to the pad and bushings;
securing the mounting stands to the pad; and
connecting the conductors to the bushings.
